(19) United States
(12) Patent Application Publication
(10) Pub. No.: US 2025/0347653 A1
(43) Pub. Date: Nov. 13, 2025

(54) HIGH VOLTAGE PANEL FOR NON-DESTRUCTIVE TIRE TESTING

(71) Applicant: BRIDGESTONE BANDAG, LLC, Nashville, TN (US)

(72) Inventor: Howard D. Sanders, Batavia, IL (US)

(73) Assignee: BRIDGESTONE BANDAG, LLC, Nashville, TN (US)

(21) Appl. No.: 18/861,091

(22) PCT Filed: Apr. 17, 2023
(86) PCT No.: PCT/US2023/065837

§ 371 Date: Oct. 28, 2024

Related U.S. Application Data
(60) Provisional application No. 63/336,522, filed on Apr. 29, 2022.

(51) Int. Cl. G01N 27/61; G01M 17/02

(52) U.S. Cl. CPC G01N 27/61; G01M 17/02

(57) ABSTRACT

A high-voltage panel in a tire defect detection system is provided. The panel includes a high-voltage power supply, a switch, and a transformer. The high-voltage power supply is configured to receive a low voltage from a low-voltage power supply and convert the low voltage to a high voltage. The switch is a thyristor-based device that is configured to facilitate the discharge of the high voltage from the high-voltage power supply. The transformer is a solid toroid transformer configured to receive the high voltage from the high-voltage power supply and provide the high voltage to a detection head of a defect detector system.

### FIELD

The present disclosure relates generally to detection of damage or flaws in tires.

### BACKGROUND

New tires are generally costly. As a result, replacing and maintaining tires can be a financial burden for companies and individuals who manage numerous vehicles, e.g., a fleet of vehicles, or who otherwise place excessive wear on their tires. As a result, repairing damaged tires rather than replacing them with new tires is of increased interest.

Diagnosis is usually the first step in repairing a damaged or flawed tire. Typically, diagnosis includes ascertaining if any foreign objects are embedded in the tread portion of the tire or if any cracks, fissures, or holes exist therein. If such defects are found to exist, the tire may be deemed to warrant repair. In some circumstances, if the defect cannot be located, the tire must be replaced.

### SUMMARY

One technique for finding defects in a tire is visual inspection. Visual inspection generally may be performed by rotating a tire on a mounting stand while an inspector visually observes the tread portion of the tire as it passes beneath the inspector's gaze. Visual inspection of a tire tends to be slow and time consuming. More importantly, however, this method for searching for defects is unreliable. This is because some defects are so minute that they escape the detection of even a trained, experienced observer. Even these undetected defects can weaken the tire and become a hazard to vehicles operating at high rates of speed.

In an attempt to solve some of the problems associated with visual inspection, other types of testing techniques have been devised.

In some testing systems, the tread portion of a tire is sandwiched between a pair of electrodes across which a high voltage electrical potential is generated. With this system, if objects such as nails are embedded in the tread portion of the tire or if defects such as orifices or fissures exist, the voltage applied across the electrodes may cause arcing at the point of foreign object or defect. To inspect the complete tire, an inspection device typically rotates the tire such that the tread portion passes between the electrodes. An electronics package is generally included in conjunction with the electrodes, which can stop rotation of the tire and trigger an alarm when a defect is detected. Pinpointing the location of the defect is thereby facilitated.

However, even with such systems, problems can occur related to the longevity, reliability, and consistency of the defect detection. The present disclosure provides exemplary non-limiting embodiments of an electronics package capable of providing reliable and consistent detection of defects in a tire.

At least one embodiment relates to a high-voltage panel for use in a tire flaw detection system. The panel includes a high-voltage power supply, a switch, and a transformer. The high-voltage power supply is configured to receive a low voltage from a low-voltage power supply and convert the low voltage to a high voltage. The switch includes a plurality of solid state components configured to facilitate the discharge of the high voltage from the high-voltage power supply. The transformer is a solid toroid transformer configured to receive the high voltage from the high-voltage power supply and provide a high voltage to a detection head of a defect detector system.

At least one embodiment relates to a high-voltage panel for use in a tire flaw detection system. The panel includes a high-voltage power supply, a switch, and a transformer. The high-voltage power supply is configured to receive a low voltage from a low-voltage power supply and convert the low voltage to a high voltage. The switch includes a thyristor configured to facilitate discharge of the high voltage from the high-voltage power supply. The transformer is a solid toroid transformer configured to receive the high voltage from the high-voltage power supply and provide a high voltage to a detection head of a defect detector system. The switch selectively connects and disconnects a first side of a primary winding of the transformer to the high-voltage power supply.

At least one embodiment relates to a method for testing a tire for defects using a high-voltage panel. The method includes initiating a start testing process via an operator. The method also includes sending a command from a controller PCT assembly to a high-voltage PCB assembly to trigger a high-voltage pulse. The method also includes receiving the command from the controller PCB assembly to the high-voltage PCB assembly. The method also includes starting a high-voltage power supply via a microcontroller. The method also includes charging an internal capacitor to a level determined by a setting of the controller PCB assembly for a given amount of time via the high-voltage power supply. The method also includes stopping the charging of the capacitor and triggering a switch, via the microcontroller, which discharges the capacitor of the high-voltage power supply through a transformer.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a diagram of a flaw detection system, according to an example embodiment,

FIG. 2 is a flow diagram of a high-voltage panel of the flaw detection system of FIG. 1,

FIG. 3 is a plot of a voltage rise detected by a voltage monitor of the high-voltage panel of FIG. 1 compared to the output voltage of a high-voltage power supply of FIG. 1,

FIG. 4 is a plot of a voltage rise detected by a voltage monitor of a commercially available high-voltage panel, and

FIG. 5 is a plot of a current detected by a current monitor of the commercially available high-voltage panel,

FIG. 6 is a plot of a current detected by a current monitor of the high-voltage panel of FIG. 1 compared to an externally calibrated output current.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Throughout the specification and claims, the following terms take at least the meanings explicitly associated herein, unless the context dictates otherwise. The meanings identified below do not necessarily limit the terms, but merely provide illustrative examples for the terms. The use of singular or plural in a situation is not meant to preclude the alternative such that singular may also include plural instances and plural instances may also include singular instances.

The term “switch” or “switching device”, either in singular or plural, may refer to a variety of transistors as known in the art including, but not limited to FET, MOSFET, IGBT, IGCT, BJT, etc., as well as SCR, thyristors, MOS gated thyristors, MOS controlled thyristors, or any other solid state device. Any reference to “gate” or “base” refers to the control connection of the switching device. Any reference to “source” could also be a reference to emitter for an IGBT or cathode for a thyristor. The term switching device may also include multiple independent devices acting simultaneously at the same point in the circuit, either in parallel or in series, as may be used to increase the current or voltage capability.

The term “transformer” refers to the section between the inverter and the high voltage rectifier. The term “transformer” also refers to the section between the switch (e.g., switch 116) and the detection head (e.g., detection head 54). The transformer may be either a core type transformer or a shell type transformer. The term “core” refers to the magnetic material around which the primary and secondary wires of the transformer are wound. The term “primary” refers to the wire connected to the “upstream” or primary side, such as the inverter and the switch, while the term “secondary” refers to wires connected to the “downstream” or secondary side, such as the high voltage rectifier and the detection head. The core material may include powder, ferrite, tape wound iron alloys, or amorphous or nanocrystalline materials or any combination thereof. The core may be made up of multiple independent components such that wires are wound around several different units either in parallel or series configuration. As a non-limiting example, a core might include two ferrite toroids and the wires are wound around them both stacked together, thereby increasing the area included in each turn, or the wires are wound around them separately either in parallel or in series, resulting in double the output current or output voltage as obtained from one ferrite toroid by itself.

The term “high voltage rectifier” refers to the set of diodes which are configured to convert an alternating current on the secondary winding into a direct current of a polarity to charge the load to high voltage. The high voltage rectifier may include other passive parts such as resistors and capacitors. Other components on the secondary side of the transformer may include feedback voltage or current monitors to allow control of the output to a specified voltage or current level.

Referring generally to the figures, a high-voltage panel 100 for a flaw detection system 50, such as those used for non-destructive detection of road tires, is shown and described according to a non-limiting embodiment. Through the use of the high-voltage panel 100 and the flaw detection system, tire defects and other characteristics of the tire can be detected with increased accuracy and increased reliability. The various systems described herein improve the readability and reliability of the measurements and signals received by the flaw detection system.

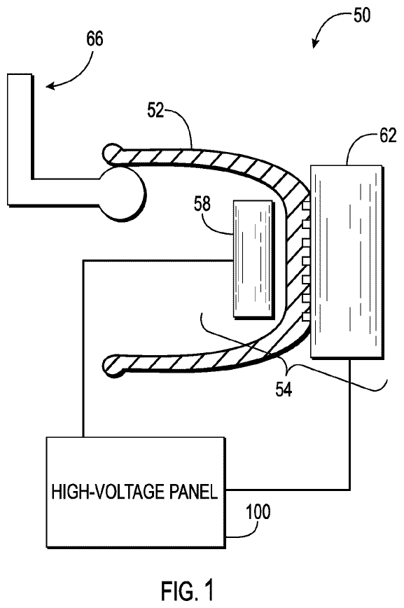

Referring to FIG. 1, a diagram is shown of the various elements which make up an example flaw detection system 50 according to at least one embodiment. The flaw detection system 50 enables the detection of flaws (defects) in a tire (e.g., a worn tire, a tire casing, a buffed tire, etc.) 52. The flaw detection system 50 utilizes high-voltage pulses and/or arc-overs that occur when a flaw in the tire 52 is moved into an electric field formed by a high-voltage detection head 54 of the flaw detection system 50. A flaw in the tire 52 may include a puncture, excessively worn area, the presence of a foreign body (e.g., nail, stone, metal fragment, etc.) and similar flaws that may affect the integrity of the tire 52 that the ability of the tire 52 to maintain air pressure within. Two or more underlying flaws may be collectively determined as a flaw by the high-voltage detection head 54 of the flaw detection system 50 in some embodiments. The high-voltage detection head 54 includes a positive high-voltage electrode (e.g., first electrode, provider electrode, upstream electrode, etc.) 56 and a receiver electrode (e.g., downstream electrode, reference electrode, etc.) 62. The high-voltage detection head 54 is configured to receive a high-voltage pulse from the panel 100 and arc the high-voltage pulse through the tire upon detection of a flaw in the tire.

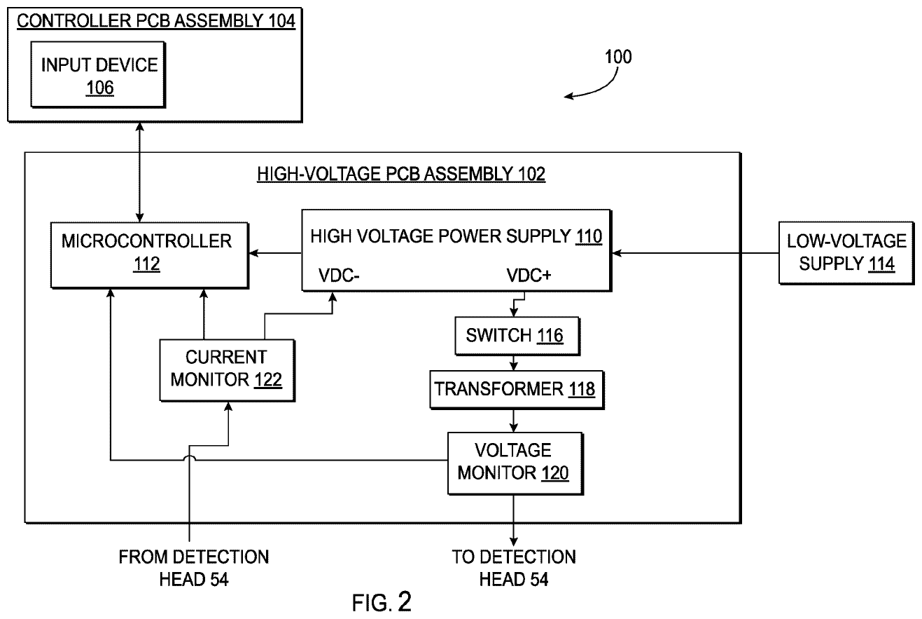

Such high-voltage pulses are produced and such arc over conditions are detected by a microcontroller (e.g., the microcontroller 112) in the high-voltage panel 100, according to some embodiments. The microcontroller 112 comprises a memory having instructions that, when sent to the processor, cause a hub (e.g., rotating hub, expandable hub, etc.) that is connected to the tire 52 to move the tire 52. Specifically, the microcontroller 112 is configured to cause the hub to rotate the tire 52 relative to the detection head 54. The microcontroller 112 is further configured to operate the high-voltage panel 100 to produce high-voltage pulses of appropriate pulse widths (e.g., between 0.4-0.5 microseconds, between 0.3-. 6 microseconds, between 0.4-0.8 microseconds, etc.) and appropriate amplitudes (such as 15 kv, 20 kv, 25 kv, 30 kv, 35 kv or 40 kv, for example) for the referenced pulse widths. The construction and operation of the microcontroller and the panel 100 will be described in greater detail below with respect to FIG. 2.

The high-voltage electrode 58 is configured for placement internal to the tire 52, as shown, so as to enable arc-overs in response to the presence of flaws in the tire 52 in proximity to the detection head 54. In some embodiments, the high-voltage electrode 58 is positioned outside of the tire 52 and the receiver electrode 62 is positioned within the tire 52. The placement of the detection head 54 shown in FIG. 1 is a preferred placement of the detection head 54 (e.g., with the high-voltage electrode 58 on the inside and the receiver electrode 62 on the outside). It is to be noted that the receiver electrode 62 (e.g., reference electrode) may or may not be placed at ground potential. It should also be noted that the high-voltage electrode 58 should be placed close to the portion of the tire that is being inspected. Therefore, the high-voltage electrode 58 may contact the interior of the tire or be spaced slightly away from the interior surface of the tire 52, as suitable for the specific high-voltage field that is generated by the detection head 54. In some embodiments, the high-voltage electrode 58 is spaced approximately 1 inch from the inside surface of the tire 52 while the receiver head 62, which may include an electrically conductive roller, contacts the tread surface of the tire 52.

In order to ensure that the entire tire 52 is inspected, the tire 52 is rotated about a central axis of the tire 52 (e.g., corresponding to the rotation of the tire 52 during use) relative to the detection head 54. In some embodiments, the detection head 54 is rotated relative to the tire 52 while the tire 52 is fixed and not rotating. In some embodiments, such as when the receiver electrode 62 is a roller, the receiver head 62 may be a drive roller configured to rotate the tire 52 about the central axis relative to the detection head 54.

In some embodiments, the flaw detection system 50 includes a pair of spreader arms 66 that act to spread beads of the tire 52 to prevent the sidewalls of the tire 52 from affecting the operation of the detection head 54. Control of the spreader arms 66 is achieved via a controller, such as the microcontroller 112 described herein. Similarly, a drive motor operably coupled to the receiver electrode 62 may be controlled via the microcontroller 112. A drive speed may be adjusted via an input interface and/or predetermined instructions stored on the memory of the microcontroller based on the size, thickness, and type of tire 52 being measured and detected using the flaw detection system 50. In some embodiments, the drive speed is about 5 in/sec. In some embodiments, the drive speed may be about 2 in/sec to about 10 in/sec. In some embodiments, the high-voltage pulse supplied to the detection head 54 is adjusted based on the amount of material (e.g., rubber) positioned between the high-voltage electrode 58 and the receiver electrode 62.

Further, in some embodiments, stopping the drive motor may also be adjusted so that the tire 52 does not continue rotating after a flaw is detected by the flaw detection system 50. This stopping may be performed so that the operator can locate and mark the location of the detected flaw. In some embodiments, the detection of the flaw is communicated to the microcontroller 112 such that the microcontroller 112 emits an alert or notification to a user (e.g., an audiovisual notification in embodiments where the microcontroller is communicated with a display system and/or a speaker system, e.g., of a computer).

After spreading the beads of the tire 52 with the spreader arms 66, the high-voltage electrode 58 is inserted into the interior of the tire 52 via a suitable mechanical linkage such that the high-voltage electrode 58 is positioned in the desired spatial relationship to the interior surface of the tire 52. The drive motor and the receiver electrode 62 may be grounded and in contact with the tread surface of the tire 52.

The flaw detection system 50 may be used to detect flaws in various types of tires, including passenger car tires, tires having fabric support layers (bias truck tires), tires having steel support layers (radial truck tires), and similar tires. In some embodiments, the microcontroller 112 includes a “bias mode” for detecting the flaws in a tire having no metal support layers. The microcontroller may adjust the voltage of the high voltage pulse provided by the high-voltage panel 100. In some embodiments, the microcontroller also includes a “radial mode” for detecting the flaws in tires having metal support layers. Generally, the voltage pulse provided by the high-voltage panel 100 is decreased when the tire being tested includes metal support layers because the conductivity of the metal in the tire helps the high voltage pulse to travel through the tire. Hence, the voltage pulse is lower for the “radial mode” than for the “bias mode.”

Referring now to FIG. 2, a diagram of the high-voltage panel 100 is shown, according to an example embodiment. The high-voltage panel 100 produces high-voltage pulses that are delivered to the detection head 54. The high-voltage panel 100 includes a high-voltage power supply 110 and a switch 116 and a transformer 118 positioned downstream of the high-voltage power supply 110.

The switch 116 selectively connects and disconnects one side of the primary winding of the transformer 118 to the high-voltage power supply 110. The other side of the primary winding of the transformer 118 is always connected to ground. When the switch 116 is on, current flows through the transformer 118 and is provided to the detection head 54, which is pulsed through the tire 52. The period of the oscillation of the high-voltage pulse to the tire 52 is thus determined by the electrical characteristics of the transformer 118, the detection head 54, and the switch 116. The pulse-width is about 800 ns (e.g., nanoseconds), for example. In some embodiments, the pulse width is between about 400 ns to about 1200 ns. In some embodiments, the pulse width is between about 300 ns to about 600 ns.

In some embodiments, an operator may input the type of tire into an input device, such as a touch screen (e.g., a display of the aforementioned display system), and provide instructions to the high-voltage panel 100 to provide varying voltage pulses depending upon the tire positioned within (e.g., on) the flaw detection system 50. For example, if the tire being tested is a passenger vehicle tire, the high-voltage panel 100 may produce about 30 kv pulses for bias tires and about 15 kv pulses for radial tires. For bias truck tires, the high-voltage panel 100 may product 40 kv pulses. In some embodiments, the voltage pulses may vary between tolerances, e.g., between about 10-25 kv pulses for radial tires and between about 30-50 kv pulses for bias tires.

In some embodiments, when a flaw is detected in the tire 52, an arc-over occurs between the high-voltage electrode 58 and the receiver electrode 62, and the voltage signal collapses. While tires are generally tested with the tire tread still on the tire carcass, some exemplary embodiments of the present disclosure permit detection of flaws in the tire 52 after the tire tread has been removed from the tire carcass. Typical high-voltage panels, in contrast, are unable to provide and detect voltage pulses with sufficient consistency and reliability to detect flaws in a buffed tire. Generally, typical high-voltage panels repeatedly detect false-positives, which slows down the flaw detection process and may make it impractical to detect the flaws in a buffed tire.

The high-voltage panel 100 of the present application addresses the reliability and repeatability issues associated with the high-voltage panels presently available. The high-voltage panel 100, when used with the flaw detection system 50, has been demonstrated to repeatedly and reliably detect the flaws in buffed tires.

Referring again to FIG. 2, the high-voltage panel 100 includes a high-voltage PCB assembly 102 and a controller PCB assembly 104 in operable communication with one another. The controller PCB assembly 104 is configured to control operation of the high-voltage PCB assembly 102. In some embodiments, the controller PCB assembly 104 includes an input device 106 configured to receive a command from an operator and send the command to the high-voltage PCB assembly 102.

The high-voltage PCB assembly 102 includes a high-voltage power supply (e.g., pulse generating circuit, power supply, etc.) 110. The high-voltage power supply 110 may be the high-voltage power supply described in U.S. Pat. No. 11,063,519, incorporated herein by reference in its entirety for the electrical schematics and high-voltage supply information therein. The high-voltage power supply 110 is configured to receive a low voltage from a low voltage supply 114 and convert the low voltage into a high voltage. The low voltage supply 114 is provided upstream of the flaw detection system 50 and the high-voltage panel 100, and the low voltage supply 114 may be separate from the high-voltage panel 100. The low-voltage power supply may be a 120-volt alternating current wall outlet, a 24-volt direct current power supply, and similar power supplies. It should be appreciated that while the high-voltage power supply from U.S. Pat. No. 11,063,519 is described herein according to exemplary embodiments of the present application, another high-voltage power supply or high-voltage converter may be used to operate the flaw detection system 50.

The high-voltage power supply 110 is used in conjunction with a microcontroller 112 to receive power from the low voltage supply 114 and to convert the low voltage into a high voltage signal at an output of the high-voltage power supply, labeled as VDC+ in FIG. 2.

When testing the tire, an operator starts the tire detection process by initiating a start testing process, such as by pressing a start button of the input device 106 communicatively coupled with the high-voltage panel 100. After the start testing process is initiated, the controller PCB assembly 104 sends a command to the high-voltage PCB assembly 102 to trigger a high-voltage pulse.

When the high-voltage PCB assembly 102 receives the command from the controller PCB assembly 104, the microcontroller 112 starts the high-voltage power supply 110. The high-voltage power supply 110 charges an internal capacitor to a level determined by a setting of the controller PCB assembly 104, such as whether the tire being detected includes steel or fabric within the tire casing. In some embodiments, the microcontroller 112 can direct a lesser charge onto the capacitor in the case of a radial tire than in the case of a bias tire to prevent false arcing when a radial tire is tested. Charging or discharging the capacitor supplies a fixed amount of energy to the high-voltage electrode 58. While the energy supplied by the capacitor to the electrodes 58 is fixed, the voltage at the electrodes 58 varies depending on the impedance of the tire being tested. For example, a radial tire has a lower impedance than a bias tire. The microcontroller 112 is configured to cause charging of the capacitor of the high-voltage power supply 110 for a given amount of time (which may be a predetermined amount of time). After that time elapses, the microcontroller 112 stops the charging of the capacitor and triggers a switch 116, which discharges the capacitor of the high-voltage power supply 110 through the transformer 118. In some embodiments, the transformer 118 has a turn ratio of between 80:12 and 150:8, inclusive. In some embodiments, the secondary winding includes 80 turns and the primary winding includes 8 turns. In some embodiments, the secondary winding includes 150 turns and the primary winding includes 12 turns. In the embodiment shown, the transformer 118 has a turn ratio of about 126:10, such that a capacitor (e.g. the capacitor of the high-voltage power supply 110) charged to about 2,500 volts creates a high-voltage pulse of about 31,500 volts on the high-voltage detection head 54 of the flaw detection system 50. In an alternative embodiment, the transformer 118 has a turn ratio of about 121:12, such that a capacitor (e.g. the capacitor of the high-voltage power supply 110) charged to about 2,900 volts creates a high-voltage pulse of about 40,000 volts on the high-voltage detection head 54 of the flaw detection system 50.

The switch 116 is a thyristor-based device. More specifically, the switch 116 is a MOS gated thyristor. The switch 116 includes three thyristors in series. In some embodiments, the switch 116 may be a silicon-controller rectifier (SCR) that selectively discharges the capacitor of the high-voltage power supply 110 in response to a signal received from one of the microcontroller 112 or the high-voltage power supply 110.

Compared to transistors, such as an IGBTs, the thyristors of the switch 116 turn more quickly to a lower on-state resistance than an IGBT such that the three thyristors in series have lower losses than, for example, ten IGBTs in series. The higher efficiency of the thyristor-based switch 116 allows for the use of a lower voltage at the same discharge energy. While thyristors and transistors use similar discharge energy, transistors and thyristors do so using different voltages. In experimentation, a transistor-based replacement switch for the switch 116 was empirically measured to use about 5.6 kV (e.g., kilovolts, thousands of volts, etc.) with about 17 nF (nanofarads) or about 0.26 J (e.g., joules) per pulse. In contrast, according to some embodiments, the switch 116 with the thyristor-based devices uses about 2.3 kV at about 94 nF. This difference between the transistor-based switch and the switch 116 means that the transformer 118, when used with the switch 116, has about twice the ratio (e.g., winding ratio) as a transformer used with the transistor-based device, to achieve the same peak output voltage to the tire.

However, in some embodiments, the peak current rating of the transistor-based switch is only about 360 A (e.g., amps) while the peak current rating of the switch 116 may be about 7 kA (e.g., kiloamps). This difference means that the switch 116 can support a higher peak current to the transformer 118 more readily than a similarly specified transistor-based switch.

A faster switch, such as the thyristor-based switch 116, contributes to a faster voltage rise on the transformer. The switch 116 also leads to a faster current rise through an arc (e.g., the arc between the two electrodes of the detection head 54 that indicates a fault in the tire). Both of these features, alone and/or combined, contribute to the ability of the microcontroller to determine whether a fault is detected by the detection head 54. In particular, the detection capability is enhanced because the switch 116 produces a higher signal-to-noise ratio than a transistor-based switching device.

A faster switch also requires less energy to be delivered through the tire between the electrodes of the detection head 54, which means that there is a decreased chance of damaging the tire rubber of the tire being tested, such as by burning the rubber. Faster pulses may also increase the sampling frequency of the detection head 54, meaning that a flaw detection process can be competed more quickly and/or that samples of the tire can be taken more frequently to create a highly accurate map of the tire and its defects.

The switch 116 further eliminates the need for a separate trigger circuit to trigger the switch 116. The function of triggering the switch 116 occurs in situ, i.e., within the switch 116. Hence, there is no need for a separate trigger circuit that triggers the switch 116 to discharge the capacitor of the high-voltage power supply 110 to the transformer 118. In some embodiments, such as when the switch 116 is replaced with a transistor-based switch, a voltage supply, such as a 48 volt direct current supply, is required to operate the switch and to send the high voltage from the high-voltage power supply 110 to the transformer 118. Elimination of the trigger circuit and the trigger voltage supply improves the reliability of the high-voltage panel 100 as the reduction in part count (e.g., elimination of a trigger circuit that is known to fail and require system downtime) increases the mean time between failures (MTBF). The elimination of a ground loop through the trigger circuit also reduces signal noise, which generally enhances the reliability of fault detection by the microcontroller 112.

### Voltage Monitor

The panel 100 further includes a voltage monitor 120 configured to receive and measure the high voltage supplied to the detection head 54 of the flaw detection system (e.g., the voltage received from the tire, as shown in FIG. 2). The voltage monitor 120 includes metal oxide resistors. Specifically, the voltage monitor 120 includes three metal oxide resistors coupled in series. Metal oxide resistors have a much higher accuracy and lower capacitive coupling than ceramic composition resistors that have been used in some conventional devices. The voltage monitor 120 is also fully encapsulated within a housing, such as potting, shielding, and the like. Encapsulation of the voltage monitor 120 prevents the voltage monitor 120 from suffering coronal discharges, or the creation of ozone, during operation. Lower capacitive coupling reduces signal noise and leads to a more accurate representation of the voltage at the detection head (e.g., the voltage arcing across the tire tread).

In some embodiments, the voltage monitor 120 may be replaced with a voltage monitor that includes ceramic resistors instead of metal oxide resistors. For example, the resistors may be 3.3 kohm, 2 W (e.g., 3.3 kilo-ohm, 2 watt) resistors or may have a different kilo-ohm or Watt rating. Specifically, a plurality of such resistors (e.g., ten resistors) may be provided in series to serve as the voltage monitor in place of the voltage monitor 120. However, ceramic resistors may suffer from coronal discharge during use, which is undesirable. Such coronal discharge may be due to field enhancement around the high voltage connector between the voltage monitor and the detection head 54. The small diameter leads of the ceramic resistors may also contribute to the coronal discharges. To reduce the occurrence of coronal discharge in ceramic composition resistors, a dielectric material may be added to the voltage monitor in some embodiments.

### Current Monitor Location

The high-voltage PCB assembly 102 further includes a current monitor 122 configured to receive the return current from the tire (e.g., from at least one of the electrodes of the detection head 54), measure the current, and send a signal to the microcontroller 112. In some embodiments, the current monitor 122 uses a 20 MHz ADC (e.g., megahertz analog-to-digital converter) to convert the current monitor signal into recordable data. By placing the current monitor 122 in a position to measure the current flowing back to the low-voltage end (e.g., VDC-) of the high-voltage power supply 110, signal noise of the reading by the current monitor 122 can be reduced when compared to placing a current monitor configured to measure a current flowing toward the tire, or out of the high-voltage end (e.g., VDC+) of the high-voltage power supply 110. Less noise from the current monitor 122 means that the microcontroller 112 can more accurately detect a fault in the tire being detected.

The current monitor 122 further includes a ¾-turn (e.g., three-quarter-turn) potentiometer located at a position accessible to an operator, such as at a top of an enclosure of the current monitor 122. The potentiometer serves as a variable resistor for the current monitor 122. This allows the current monitor signal to be adjusted to either increase or decrease sensitivity. Lower sensitivity is useful for tires with thin or removed tread while higher sensitivity is useful for tires with thicker tread.

To prevent shorting of the high voltage to the panel 100, the panel 100 is formed of an insulating material, such as a polymeric material, to which the high-voltage PCB assembly 102 is coupled.

### Transformer

The high-voltage panel 100 includes the transformer 118. The transformer 118 receives the high voltage from the high-voltage power supply 110 when the switch 116 is triggered. The transformer 118 includes a core and wire windings. The core may be a toroid core, split core, laminate core, or amorphous core. In some embodiments, the core is made from a ferrous material, such as iron. In some embodiments, the core is formed of nanocrystalline. The wire windings may be insulated and configured to support high-voltage loads. In some embodiments, the transformer 118 includes a solid (e.g., non-split, non-laminate), nanocrystalline toroid core having insulated wire windings. The solid toroid core and the insulated wire increase the durability of the transformer 118 by lending structural strength and resilience. In particular, the increased durability is beneficial when the transformer 118 is moved during transit and when the transformer 118 undergoes thermal cycling caused by the various environments where the panel 100 is used. The solid toroid core and the insulated wire also contribute to decreased signal noise and signal degradation. Less noise and a more stable signal from the transformer 118 mean that the microcontroller 112 can more accurately detect a fault in the tire on the detection apparatus.

In some embodiments, the transformer 118 may be replaced with a split-core transformer having a plurality of windings (e.g., three stacked sets of spiral windings of magnet wire). The innermost and outermost set of windings are connected in series as the secondary winding, and the middle set of windings is the primary winding. One difference between a split-core transformer as compared to a solid toroid core transformer (e.g., the transformer 118) is that in a split-core transformer, the spacing of the split-cores are such that field enhancement results in partial discharge inside the transformer. The partial discharge in turn may generate noise that is picked up by the current and voltage monitors. The noise caused by the split-core transformer may result in false-positive and false-negative fault detection in the tire. A second difference when using a split-core transformer is that the two sides of the split core must to be held in close contact to guarantee an accurate signal. Anything that reduces the contact between the two portions of the split-core affects the efficiency of the split-core transformer. Some factors that may affect the contact between the portions of the split-core are epoxy getting between the two portions or thermal cycling causing the two portions to mechanically move apart. In some embodiments, the high-voltage panel 100 may include a solid toroid core and insulated wire to mitigate or prevent these issues. A third difference between split-core transformers as compared to solid toroid core transformers is that they may be more susceptible to damage and separation of the core upon rough handling and cyclic thermal loading.

### Data

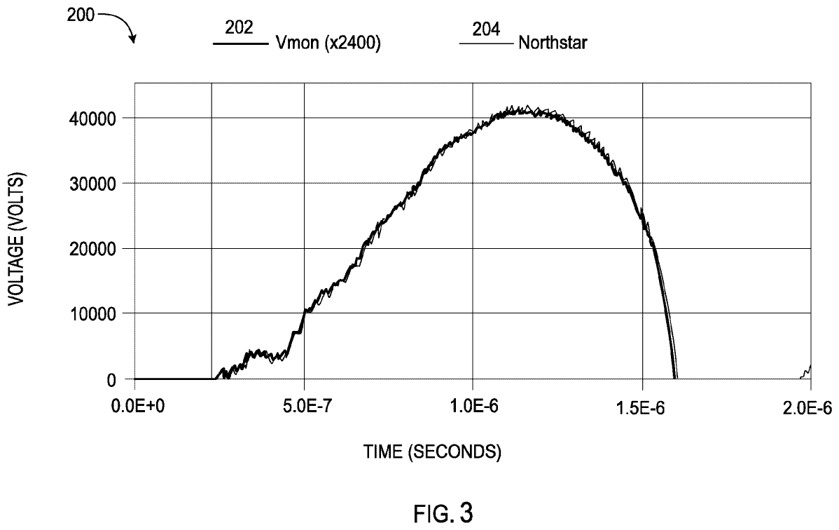

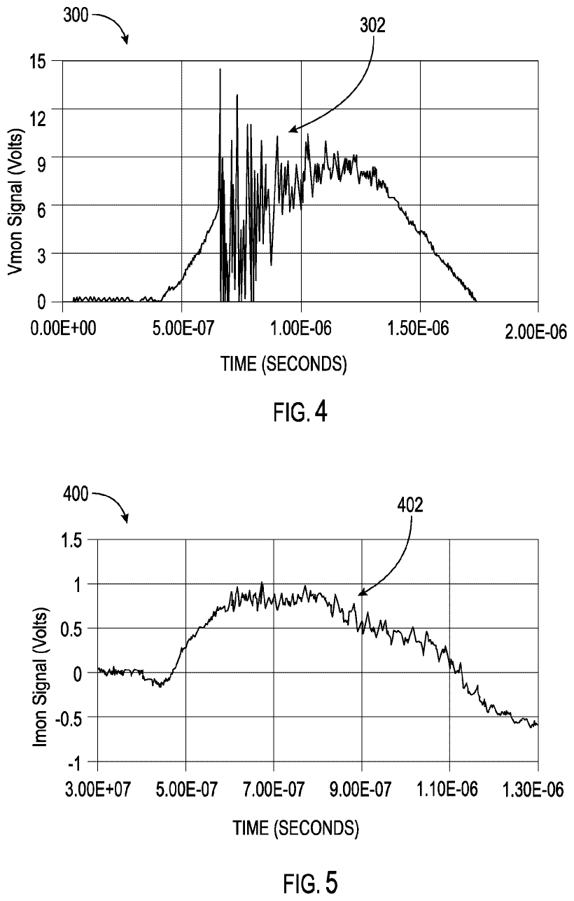

Referring now to FIG. 3, a plot 200 showing test data from the panel 100 is shown. The chart 200 shows the voltage rise (volts) through the transformer 118 over time (seconds). The panel voltage 202 (e.g., Vmon (x2400)) measured by the voltage monitor 120 is shown in comparison to an externally calibrated voltage probe that measures the same voltage, a calibrated output voltage 204, as the voltage monitor 120. As shown in comparison to the data of FIGS. 4 and 5, the voltage rise of the panel voltage 202 is smooth and substantially matches the calibrated output voltage 204 measured by the externally calibrated voltage probe.

Turning now to FIG. 4, plot 300 shows the voltage rise of the panel 100 over time using a transistor-based switch and a split-core transformer. As can be seen, the voltage signal 302 from the voltage monitor is noisy and shows larger spikes, which may cause the microcontroller 112 to register a false-positive flaw detection. Similarly, FIG. 5 shows a plot 400 of the current 402 over time as the current 402 travels through the panel 100 using a transistor-based switch and a split-core transformer during the voltage rise. The current 402 is measured using a current monitor, such as the current monitor 122. An undesirable aspect of commercially-available high-voltage panels is that the current monitor registers a negative current as the voltage rises, which is a result of capacitive coupling between the high-voltage output and the current monitor caused by the current monitor being on the high-voltage output side rather than on the low-voltage return side of the circuit. The changes outlined above with respect to the panel 100, namely the switch 116, the voltage monitor 120, the current monitor 122, and the transformer 118, contribute to the smooth voltage measurement shown in FIG. 3 as opposed to the less uniform behavior shown in FIGS. 4 and 5.

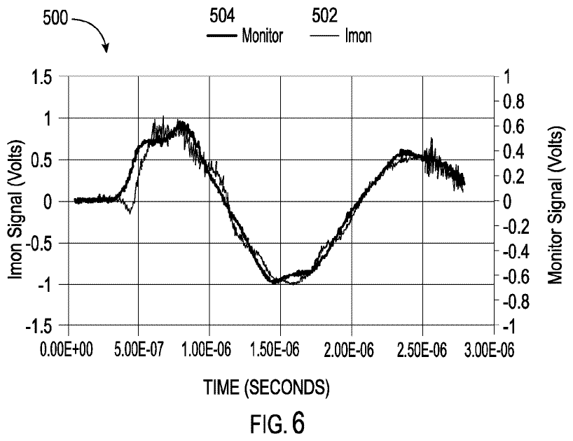

Turning now to FIG. 6, a plot 500 showing test data from the panel 100 is shown. The chart 500 shows the current rise (0.1 volts per amp) through the transformer 118 over time (seconds). The panel current 502 (e.g., Imon) measured by the current monitor 122 is shown in comparison to an externally calibrated current monitor that measures the same current, a calibrated output current 504 (e.g., Monitor), as the current monitor 122.

Generally, the flaw detection method is completed on a worn tire before the tire is buffed and the old tread is removed. In some embodiments, it may be desirable to complete the flaw detection process after the tire has been buffed and the worn tread is removed from the tire. Some operators may utilize the detector to measure the tire after the tire was buffed. Notably, the detector as set forth in exemplary embodiments herein is configured to find the faults on a buffed tire. This is a significant improvement over the original panels and detectors incapable of detecting faults (defects) on a buffed tire.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical or electrical.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

1. A high-voltage panel for use in a tire defect detection system, the high-voltage panel comprising:
a high-voltage power supply configured to receive a low voltage from a low-voltage power supply and convert the low voltage to a high voltage;
a switch comprising a thyristor configured to facilitate discharge of the high voltage from the high-voltage power supply; and
a solid toroid transformer configured to receive the high voltage from the high-voltage power supply and provide the high voltage to a detection head of the tire defect detection system.

2. The high-voltage panel of claim 1, wherein:
the detection head of the tire defect detection system includes a voltage input and a voltage output; and
the high-voltage panel further comprises a voltage monitor operably coupled to the voltage output and configured to measure a voltage signal at the voltage output.

3. The high-voltage panel of claim 1, further comprising a current monitor operably coupled to the detection head and configured to measure a current flowing through the detection head.

4. The high-voltage panel of claim 1, further comprising a voltage monitor operably coupled upstream of the detection head and configured to measure a voltage provided to the high-voltage power supply.

5. The high-voltage panel of claim 1, further comprising a microcontroller configured to receive voltage information relating to the high voltage supplied to the detection head and configured to control a position of a tire relative to the detection head.

6. The high-voltage panel of claim 5, wherein the switch comprises three thyristors in series.

7. The high-voltage panel of claim 6, wherein the switch is a silicon-controller rectifier that selectively discharges a capacitor of the high-voltage power supply in response to a signal received from the microcontroller.

8. The high-voltage panel of claim 6, wherein the switch is a silicon-controller rectifier that selectively discharges a capacitor of the high-voltage power supply in response to a signal received form the high-voltage power supply.

9. A high-voltage panel for use in a tire defect detection system, the high-voltage panel comprising:
a high-voltage power supply configured to receive a low voltage from a low-voltage power supply and convert the low voltage to a high voltage;
a switch comprising a thyristor configured to facilitate discharge of the high voltage from the high-voltage power supply; and
a solid toroid transformer configured to receive the high voltage from the high-voltage power supply and provide the high voltage to a detection head of the tire defect detection system,
wherein the switch selectively connects and disconnects a first side of a primary winding of the solid toroid transformer to the high-voltage power supply.

10. The high-voltage panel of claim 9, wherein current flows through the solid toroid transformer and is provided to the detection head of the tire defect detection system when the switch connects the first side of the primary winding of the solid toroid transformer to the high-voltage power supply.

11. The high-voltage panel of claim 10, wherein current is pulsed through a tire after current is provided to the detection head of the tire defect detection system.

12. The high-voltage panel of claim 11, wherein a period of an oscillation of a high-voltage pulse to the tire is determined by electrical characteristics of the solid toroid transformer, the detection head, and the switch.

13. The high-voltage panel of claim 9, wherein:
the detection head of the tire defect detection system includes a voltage input and a voltage output; and
the high-voltage panel further comprises a voltage monitor operably coupled to the voltage output and configured to measure a voltage signal at the voltage output.

14. The high-voltage panel of claim 9, further comprising a current monitor operably coupled to the detection head and configured to measure a current flowing through the detection head.

15. The high-voltage panel of claim 9, further comprising a voltage monitor operably coupled upstream of the detection head and configured to measure a voltage provided to the high-voltage power supply.

16. The high-voltage panel of claim 9, further comprising a microcontroller configured to receive voltage information relating to the high voltage supplied to the detection head and configured to control a position of a tire relative to the detection head.

17. A method for testing a tire for defects using a high-voltage panel, the method comprising:
initiating a start testing process via an operator;
sending a command from a controller PCB assembly to a high-voltage PCB assembly to trigger a high-voltage pulse;
receiving the command from the controller PCB assembly to the high-voltage PCB assembly;
starting a high-voltage power supply via a microcontroller;
charging an internal capacitor to a level determined by a setting of the controller PCB assembly for a given amount of time via the high-voltage power supply; and
stopping the charging of the internal capacitor and triggering a switch, via the microcontroller, which discharges the internal capacitor of the high-voltage power supply through a transformer.

18. The method of claim 17, further comprising initiating the start testing process by pressing a start button of an input device communicatively coupled with the high-voltage panel.

19. The method of claim 17, wherein the level determined by a setting of the controller PCB assembly depends on whether the tire includes steel or fabric within a casing of the tire.

20. The method of claim 17, wherein the microcontroller directs a lesser charge onto the internal capacitor for a radial tire than for a bias tire to prevent false arcing when the radial tire is being tested.
